(19) United States
(12) Patent Application Publication
(10) Pub. No.: US 2013/0218728 A1
(43) Pub. Date: Aug. 22, 2013

(54) Virtual on-line pre-shopping system and method

(71) Applicants: Rick Dan Hashop, Alvin, TX (US); Susan Rene Hashop, Alvin, TX (US); Christopher Vance Burres, Houston, TX (US)

(72) Inventors: Rick Dan Hashop, Alvin, TX (US); Susan Rene Hashop, Alvin, TX (US); Christopher Vance Burres, Houston, TX (US)

(21) Appl. No.: 13/301,676

(22) Filed: Nov. 21, 2011

Related U.S. Application Data
(63) Continuation-in-part of application No. 12/189,167, filed on Aug. 10, 2008, now abandoned.

(51) Int. Cl. G06Q 30/06

(52) U.S. Cl. CPC G06Q 30/0603
USPC 705/27.1

(57) ABSTRACT

An electronic pre-shopping system and method, that provides the consumer the option of pre-shopping for a gift item from any on-line retail outlet. The system and method provides consumer capability of accessing a retail outlet website, selecting a gift item, selectively extracting the gift item product information, associating the gift item with a future special occasion of a recipient of the gift item, storing the product information along with the recipient special occasion information into a database, securing payment for the item, and delivering the gift item to the recipient within the proscribed time period required for the special occasion. The system further provides the consumer with the option of paying for the gift item immediately or at a predetermined date in the future. The user interface further provides the capability of pre-shopping for an item from any online retail store through a software proxy process.

This is a continuation in part of Ser. No. 12/189167

### TECHNICAL FIELD

The present invention relates to computer systems, and more particularly to a system and method for facilitating shopping to various retailers via the Internet.

### BACKGROUND OF THE INVENTION

In recent years, electronic commerce conducted on the Internet has grown substantially. Because of the high level of convenience many consumers prefer to shop online. Online shopping is the process by which consumers go through to purchase products or services over the Internet. E-Commerce consists of the buying and selling of products or services over electronic systems such as the internet. Many retail stores now have websites through which consumers can purchase products and services. Now, many consumers find a product of interest by visiting the website of the retailer directly or by shopping across different websites for their products of interest.

Once a particular product of interest is found on a website of the retailer, most online retail websites use shopping cart software to allow the consumers to accumulate multiple items and adjust the quantity of items in their shopping cart. The software shopping cart is used an analogy to the physical shopping cart which holds the items while you shop. After a consumer completes shopping, payment is electronically secured from the consumer via electronic credit card authorizations software systems. Finally, once payment has been secured from the consumer, the order is then processed for delivery, and the product is then delivered by the retail store to the consumer.

Many people wait until the last minute to decide what gifts (herein also known as merchandise) to buy for a person on a special occasion. Sometimes people are so busy that they forget about a special occasion altogether. Thus, there is need for a system and a method that facilitate a person to buy merchandise in advance of a special occasion.

### SUMMARY

An electronic pre-shopping system and method for an on-line retail outlet and/or an electronic portal to various online retail outlets is provided. The system and method provides the consumer the option of pre-shopping for a gift item from an on-line retail outlet. The system and method provides the consumer the capability of accessing the retail outlet website, selecting a gift item from the website, selectively extracting from a website page the gift item product retail information, associating the gift item with a future delivery date that is not limited to a set number of days (could be several years in the future), storing the gift item product information along with the recipient delivery date, special occasion, shipment data (such as name and address),information into a database, securing payment for the gift item, and delivering the gift item to the recipient within the time period required for the delivery date requested by the consumer.

In one aspect of the present invention, the system and method allows the consumer to pay immediately when they select a gift item for a recipient.

In another aspect of the present invention, the system and method allows the consumer to pay at some predetermined time in the future prior to the delivery date of the gift item to the recipient.

In another aspect of the present invention, the system and method allows the consumer via a proxy process the ability to pay immediately when they select a gift item for a recipient.

In another aspect of the present invention, the system and method allows the consumer to shop via a proxy process with the ability to pay at some predetermined time in the future prior to the delivery date of the gift item to the recipient.

In another aspect of the present invention, the system and method provides the consumer the capability of creating wish lists and sending these wish-lists to potential consumers (potential consumer are herein also known as gifter).

In another aspect of the present invention, the system and method provides a gifter the ability of providing a restricted or unrestricted gift card to a recipient.

The present invention comprises the features hereinafter fully described and particularly pointed out in the claims. The following description and attached drawings set forth certain detail illustrative embodiments of the invention. The disclosed embodiments are intended to include all embodiments and their equivalents. Other objects, advantages, and novel features will become apparent from the following detailed description of the invention when considered in conjunction with the drawings.

### BRIEF DESCRIPTION OF THE DRAWINGS

FIG. 1 illustrates a block diagram of an electronic on-line pre-shopping system in accordance with one aspect of the present invention.

FIG. 1A illustrates sample products of interest on an online store website.

FIG. 2 illustrates a possible environment to support the on-line pre-shopping system.

FIG. 3 illustrates a block diagram of the early stage shopping method of a gift item to a recipient in accordance with one aspect of the present invention.

FIG. 3A illustrates a block diagram of the late stage shopping method of a gift item to a recipient in accordance with one aspect of the present invention.

FIG. 4 illustrates a block diagram of the late stage delivery method of a gift item to a recipient in accordance with one aspect of the present invention.

FIG. 5 illustrates a block diagram of how a user finalizes their shopping cart for their respective gift items in accordance with one aspect of the present invention.

FIG. 6 illustrates a block diagram of the early stage delivery method of a gift item to a recipient in accordance with one aspect of the present invention.

FIG. 7 illustrates a block diagram of payment for the gift item in accordance with one aspect of the present invention.

FIG. 8A illustrates a functional block diagram of the present invention.

FIG. 8 illustrates a block diagram of the method for practicing the general shopping and shipping protocol of the present invention.

FIG. 9 illustrates a block diagram of the proxy process for the selection of a gift item from any on-line website in accordance with one aspect of the present invention.

### DETAILED DESCRIPTION

In the specifications the following terms are defined
Recipient is a consumer who will or is anticipating receiving a gift; the recipient can be added to the system by a gifter or the recipient can create their own membership on the website
Gifter is a consumer who will or is anticipated to give a gift; a recipient can invite a gifter to become a member and give them a gift; a gifter can come to the website and create their own membership
Wish list is the list of items a member is interested in receiving or giving.
Gift item is an item or product that a person is interested in giving or receiving;
Proxy is the process of linking an affiliated or non-affiliated website to the pre-shopping server application process.
Unrestricted gift card is a gift card amount that is paid for by the gifter. Recipient receives an account credit which the recipient can spend.
Restricted gift card is the same as unrestricted gift card with the added feature that when the recipient spends the credit on items the gifter will be notified which items were purchased with the credit with a local area network (LAN) 32 to which the server machine 26 is connected.

In this environment a client machine 20 is a conventional local personal computer having an operating system (i.e. Windows) capable of supporting Internet Protocols (i.e. HTTP). The Personal Computer is equipped with a screen display and input/output devices through which a user interact with the local personal computer. The user input device can be a keyboard, mouse, or voice activated control device. The local personal computer 20 is operatively connected to the Internet and/or an Intranet or another computer network 22 via a modem, T1 Line, DSL or another suitable high speed line connection.

Additionally, the server machine 26 is a remote computer general purpose computer operatively connected to the computer network via a modem, T1 Line, DSL or another suitable high speed line connection. In the preferred embodiment, the remote computer is an internet based web server connected to the computer network. The general purpose computer is equipped with a screen display and a user input/output device through which an administrator interacts with the server machine 26. Each web site server machine supports web sites comprising various pages to which the local computer may connect. In the present invention, pre-shopping website or Affiliate websites would be implemented on server machines. the gifter gave to the recipient; this also includes partial payments made with the gift card.
Alternative Restricted gift card is the same as unrestricted gift card with the added feature that when the recipient wishes to spend that credit on items, the gifter will be notified which items the recipient wishes to purchase with that credit; the gifter then has the option to approve or deny the purchase; approval will result in that purchase being carried to conclusion; denial will result in that purchase being cancel.
Status of Recipient Occasions meaning
1—ok/pending; 2—item not available sending gift card; 3—pending shipment; 4—shipping; 5—cancelled; 6—sent; 7—pending gifter/member approval; 8—paid pending shipment; 9—pending gifter approval

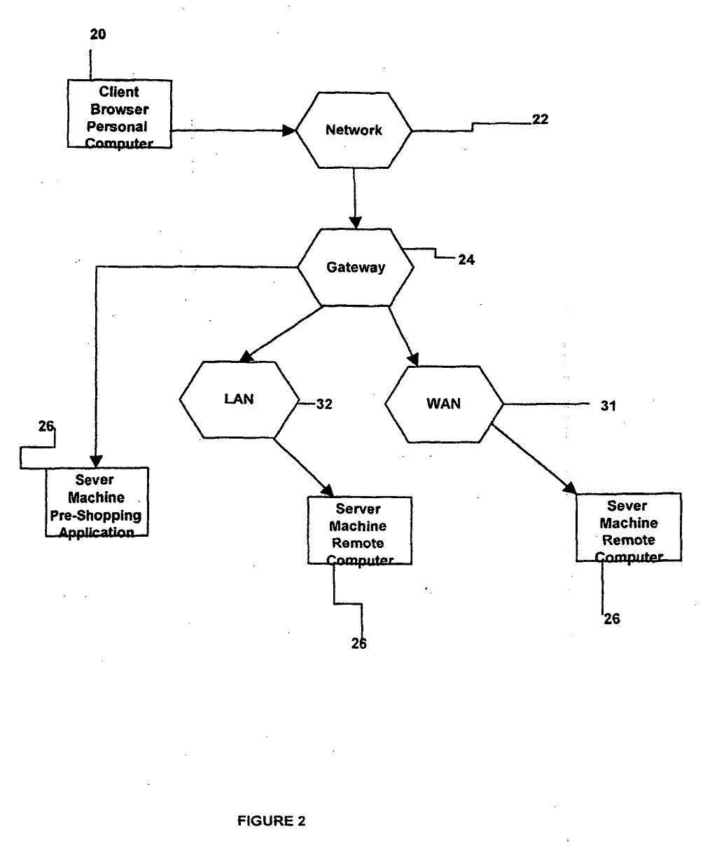

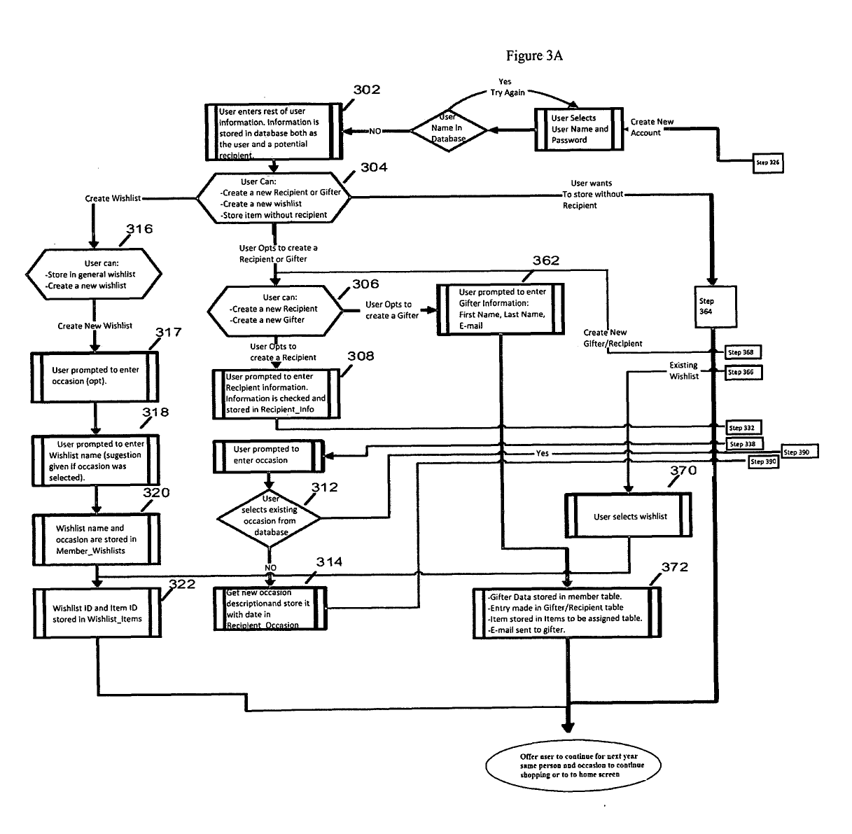

An example of a system configuration 55 to support the on-line pre-shopping system is illustrated in FIG. 2. As shown, the conventional client/server environment is preferred. The computers on the Internet can be categorized as a client machine or a server machine. In particular, the client machine communicates with the server machine over a computer network, known as the World Wide Web portion of the Internet. The server machines 26 provide services to client machines 20 over the Internet. The computer network 22 can include a gateway 24 that provides an interface to a wide area network (WAN) 31 which interfaces

In the present invention, client machine 20 runs software that includes a browser for retrieving electronic documents from the server machines for display on the local personal computer. Conventional browser software includes internet explorer or Netscape navigator. Conventional internet server provider software includes AOL or Yahoo.

In the present invention the consumer would access through a browser, pre-shopping software application, the shop4later application, stored on the server machine. The shop4 later application on the server comprises several modules implemented using HTML document language and Active Server page software environment. HTML is the mark up language that is used to describe to the web browser how to display the text contained in the web page structure. The active server page environment is responsible for receiving and responding to client requests to the server.

In one embodiment of the present invention, by way of illustration, a consumer would enter the URL, for example, www.shop4later.com, through their browser to access the website home page. Once the consumer enters the website URL, the browser sends a request to the server machine to get the initial home page of the pre-shopping website. The response includes a page structure that is static or interactive form page. Once the website page structure is sent, the browser would display the webpage to the user by executing the HTML document language. Once at the website, the consumer has the option of shopping for any product and selecting that product as their gift item.

In an alternative embodiment of the present invention, by way of illustration, the consumer would enter the URL, for example, www.amazon.com, of an affiliated or non-affiliated shopping website through their browser to access the affiliate website home page. After the user completes shopping for their gift item on the home website or the affiliate website, the user would click on a button that would initiate the main shop4later application process on the server machine. Upon initiation of the main application process, the user is given the option of logging in as an existing member or creating a new account. As described below the user will have the option of entering the early stage or the late stage shopping protocol.

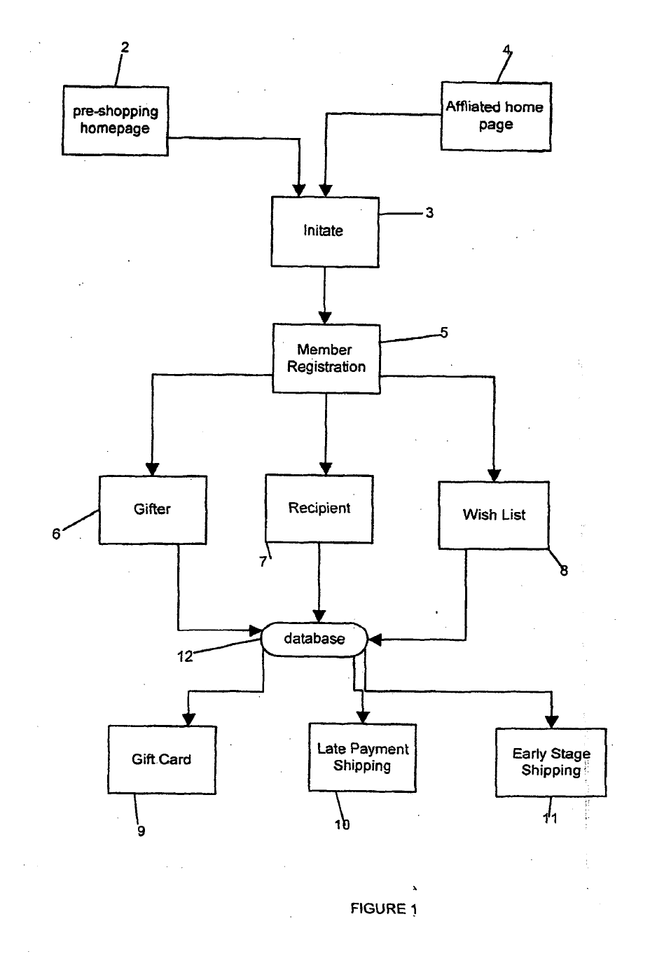

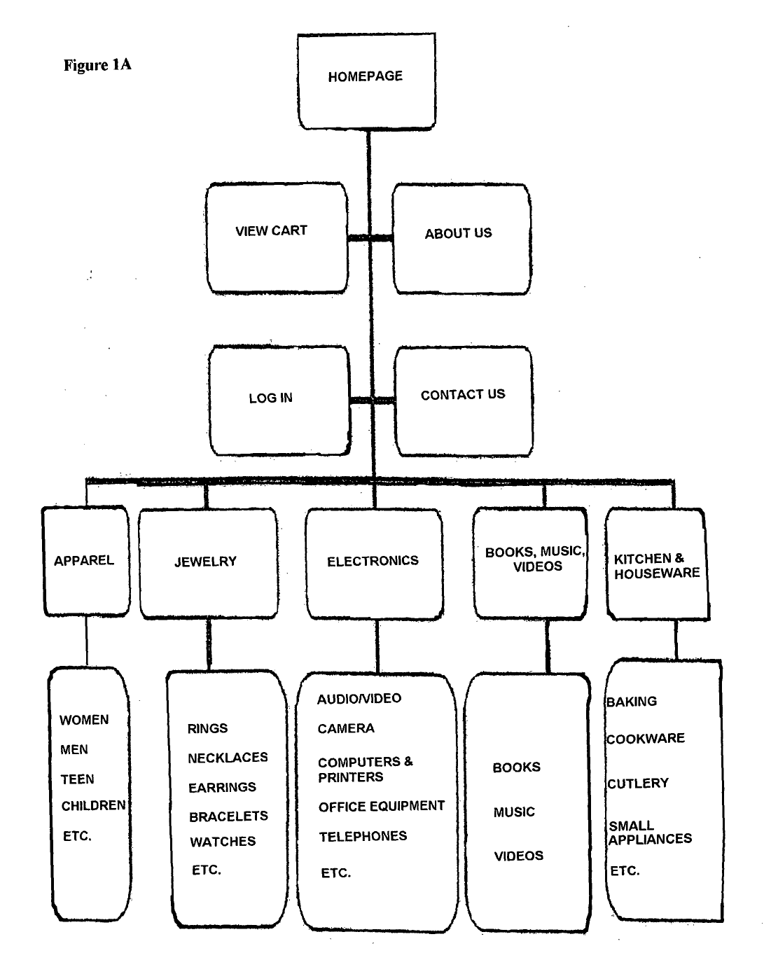

As illustrated in FIG. 1, the system comprises the various software components implemented upon the server machine: The system comprises the following modules:
Pre-shopping website 2 which generate page structures to support the shopping protocol for gift items from a single website for persons targeted to receive gifts;
Affiliate shopping websites 4 which generate page structures to support shopping for gift items on affiliated on-line stores and link to the main pre-shopping process via a proxy process or a tool bar;
Member registration 5 supports the page structures for registration of a consumer with the system;
Gifter module 6 supports the page structures for managing the relationship between the gifter and recipient;
Recipient Module 7 supports the page structures for management of a consumer registered as someone who will receive a gift;
Wishlist Module 8 supports the page structures to allow a member to create a wish list of identified gift items;
Gift card module 9 supports the page structures for payment of the gift item by a gift card;
Late stage payment module 10 supports the page structures for payment of a gift item at some predetermined time in the future before shipment of the gift item to the recipient;
Early stage payment module 11 supports the page structures for payment of the gift item immediately;
Database module 12 comprises database table structures to support the member contact information and member type (i.e. member, gifter only, recipient only and member and recipient), gift item information, gifter_recipient relationship, recipient_occasion relationship, recipient_occasion_gift item relationship, recurring_recipient_occasion _gift item relationship, member wish lists, and wish list_gift item relationship.

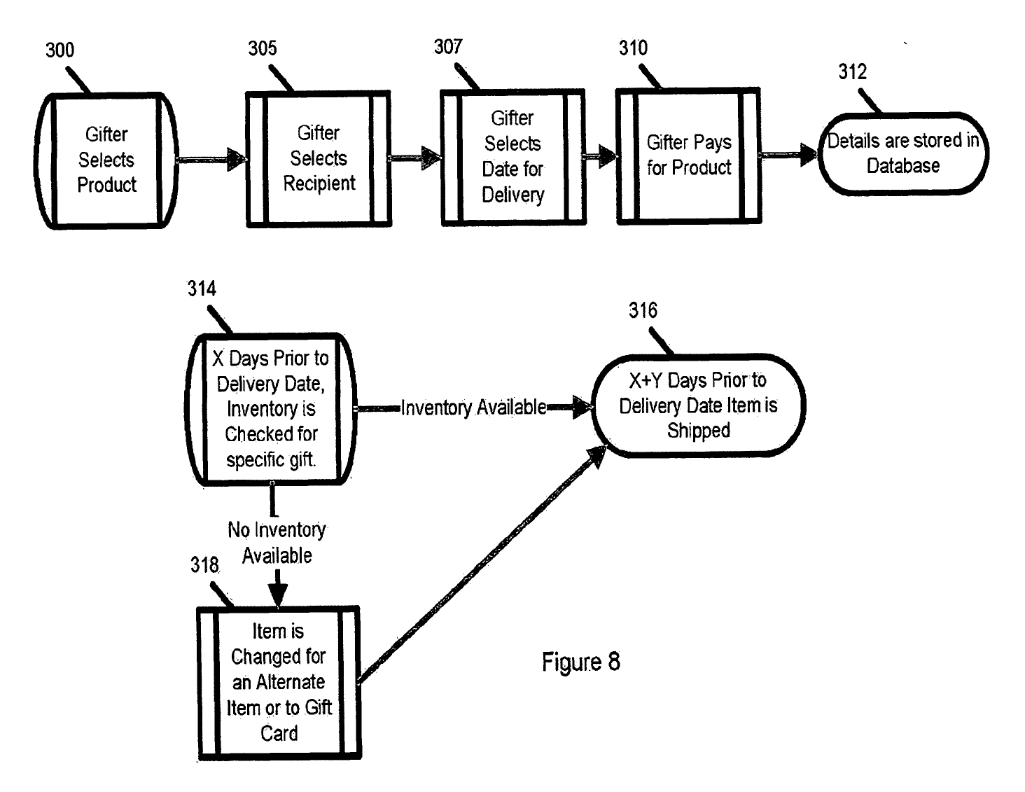

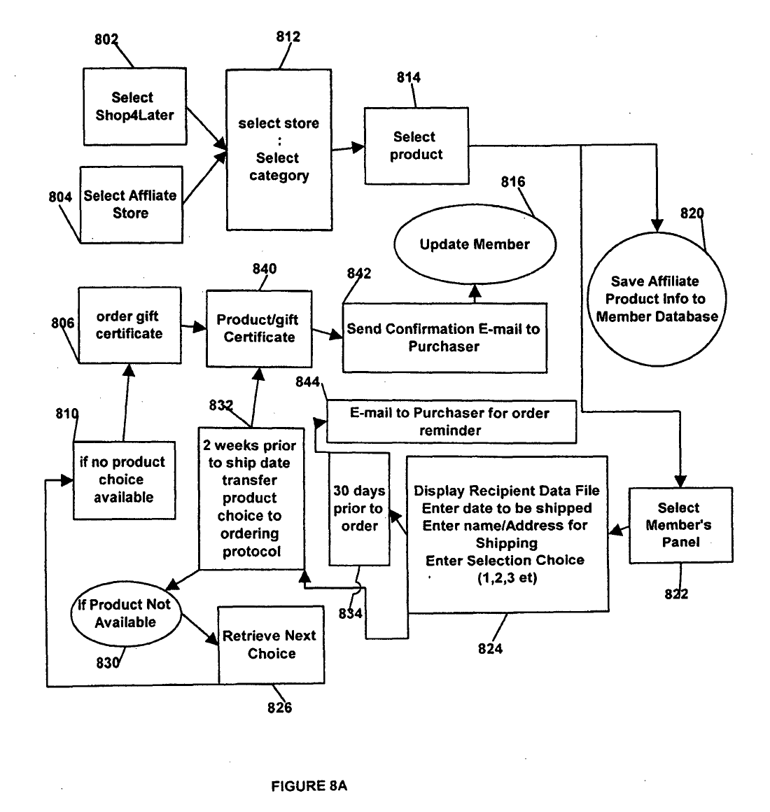

Referring to FIG. 8A, there is shown a functional block of the present invention. In accordance with the present invention, a user selects between the option at step 802 and at step 804. At option 802 the user selects the shop4later online store. In the alternative the user selects an affiliate online store at option 804. Once the user enters the selected store at step 812, the user selects a shopping category as illustrated in FIG. 1A. At step 814, the user selects a product from a particular shopping category. At step 820, the system transfers the product information to the server program for storage within the member database. At step 822, the user selects a recipient for the gift item. At step 824, for the selected recipient, the system displays the recipient data file and allows the user to enter shipping information. At step 834, if the system monitors the database to determine which orders are within 30 days of shipment and a reminder email is sent to the purchaser. At step 832, if products are within two weeks of shipment, the system enters the ordering protocol. At step 826, if product is not available any more, the system retrieves the next choice from the list. At step 806, if no product choice is available, a gift certificate is sent to the recipient. At step 842, an email confirming the purchase of the gift certificate for the recipient is sent to the purchaser.

Referring to FIG. 8, there is shown a detail overview of the method of practicing the present invention. The method includes a general shopping protocol and shipping protocol. As depicted, at step 300 a gifter shops for a product or gift item from the shop4later website 2 or an affiliate website 4. After a gifter selects a gift item for a recipient from online store website, a sample of type of product illustrated in FIG. 1A, the system captures the product information from the active website page and initiates the shop4later application process wherein the gifter is prompted to select a recipient for the gift item at step 305. Then, the gifter selects an occasion for delivery of the item at step 307. Finally, the gifter pays for the gift item immediately or at some time in the future. Then information stored in the database at step 312.

The general shipping protocol of the present invention requires on a recurring basis via a batch process on the server machine initiate the delivery event of a gift item. To accomplish this event, the system at step 314 checks the delivery date of each gift item in the database. If a gift item is scheduled for delivery for a specific occasion to a recipient, the system checks to see if the gift item is available. If the gift item is available, the system notifies the store to ship the gift item to the recipient at step 316. If gift item is not available, then an alternate item is selected or a gift card is setup.

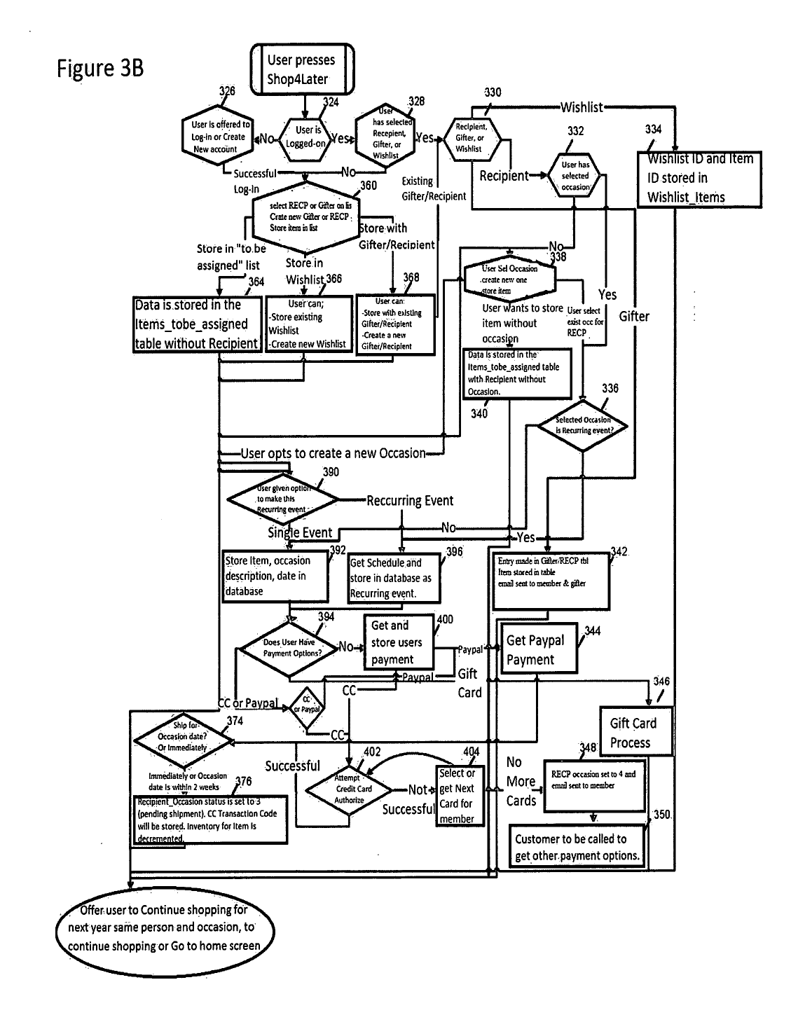

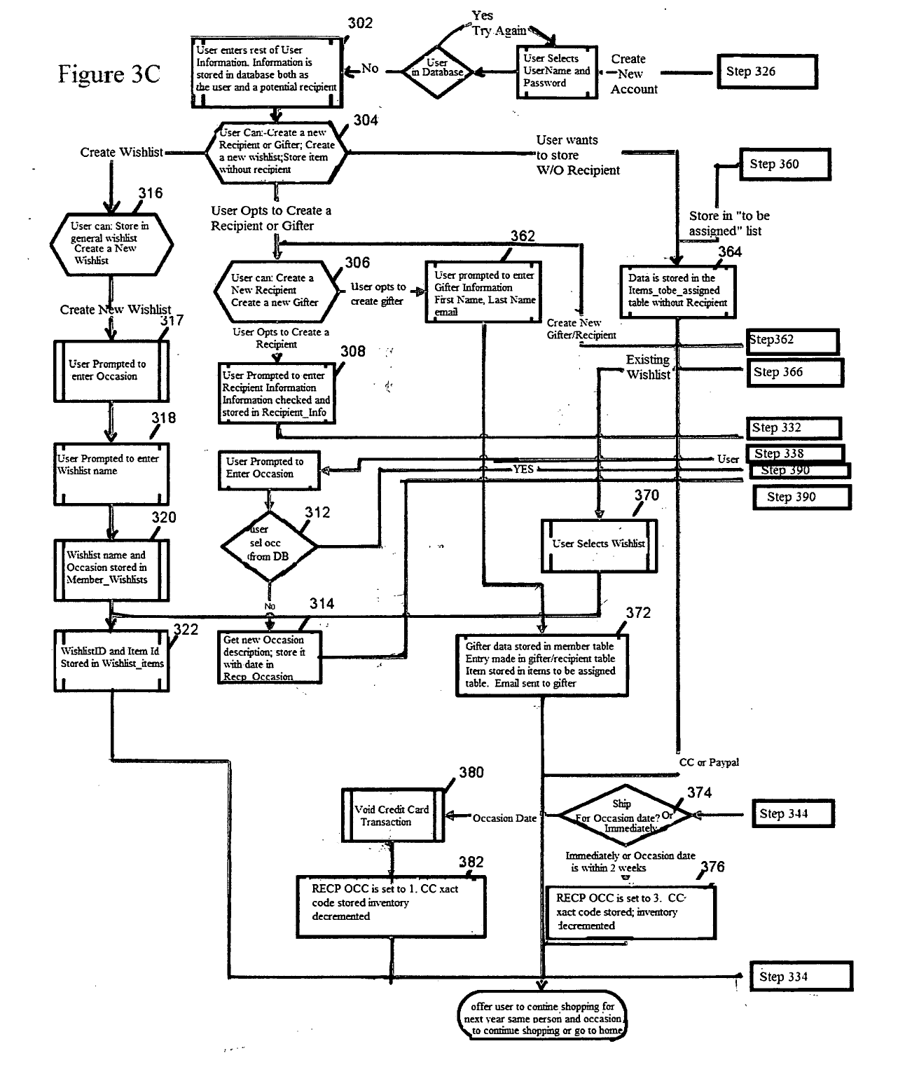

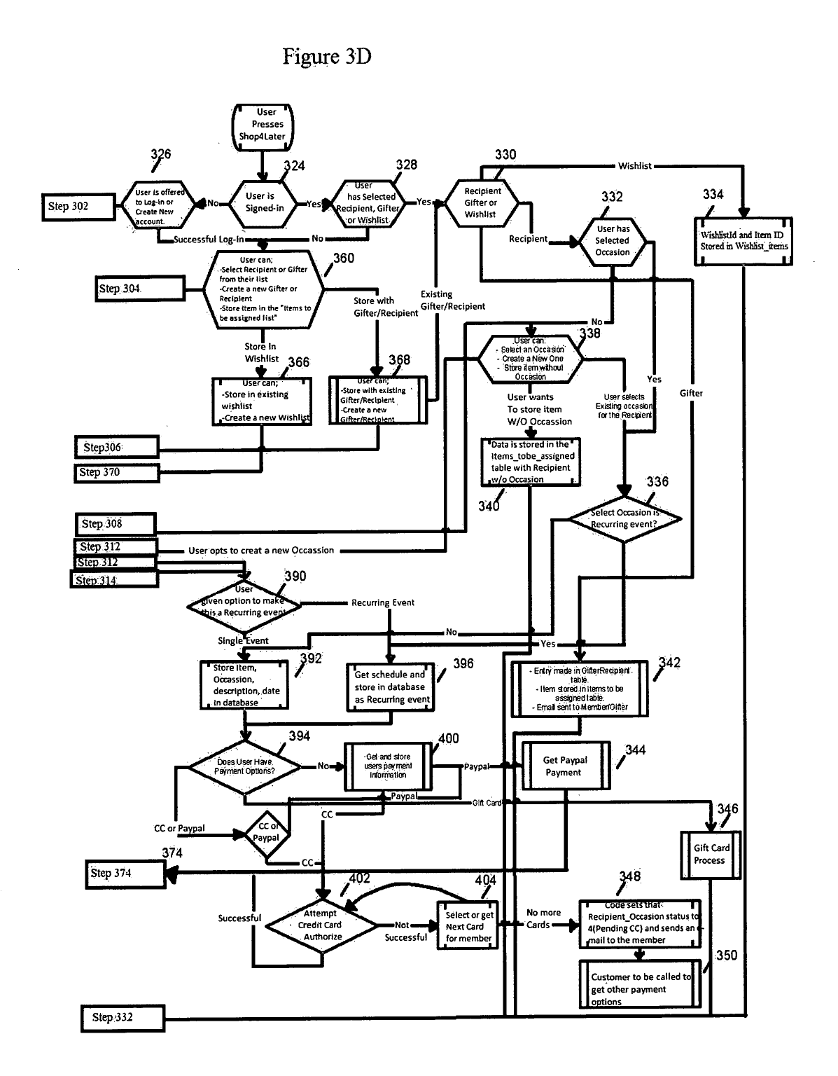

Referring to FIG. 3, there is shown the steps involved in the early stage payment shopping protocol process. In one aspect of this method, at step 326, if the consumer selects the new member, the system obtains the users contact information and registers the information with the database at 302. The system proceeds at step 304 to provide the new member the options of creating a new recipient, new gifter, new wish list, or store gift item without a recipient.

If the new member is a gifter at step 362, the system prompts the user for the gifter information and stores the information in the database at step 372. Then the new member is provided with the option of continuing shopping at the original home online store or affiliate online retail store website at step 378.

At step 316, the system allows the new member to create a wish list and associate the gift item information with the newly created wish list. The proceeds at step 317 to prompt the user to enter the occasion information, at step 318 to prompt user to provide a wish list name, at step 320 to store the wish list information in the member database table, and at step 322 to store the in the wish list table the wish list name associated with the gift item information. Then the new member is provided with the option of continuing shopping at the original home online store or affiliate online retail store website at step 378.

At step 364, the system also gives the new member the option of storing the gift item information with out a recipient. In this step, the gift item information is stored within a table identifying the gift to be assigned to a recipient at some later date in the future. Then the new member is provided with the option of continuing shopping at the original home online store or affiliate online retail store website at 378.

At step 306, in the alternative, the system also gives the new member the option of registering a new recipient. After the recipient information is stored within the database at step 308, the system proceeds to step 332 for the new member to enter an occasion. From step 332, the system proceeds to allow the new member to select an occasion as described in detail below.

If the consumer is not already logged in at step 324, the system provides the consumer the option of signing in. After signing in as an existing member, the system proceeds 360 which provide the existing member the option of selecting a gifter, recipient, create a new gifter/recipient, or store information into the items to be assigned. The system proceeds from 360 as described below.

At step 366, the system allows the existing member to create a wish list or access an existing wish list to associate the selected gift item information with the newly created wish list or the existing wish list. If the user selects an existing wish list at step 370, the system proceeds to step 322 to store the information into the existing wish list. Then the existing member is provided with the option of continuing shopping at the original home online store or affiliate online retail store website at step 378.

At step 364, the system also gives the existing member or a new member the option of storing the gift item information without a recipient. Then the existing member is provided with the option of continuing shopping at the original home online store or affiliate online retail store website at step 378.

At step 368, the system proceeds to step 306 if the existing member selects the option of creating a new recipient or new gifter. How the system proceeds from step 306 is described above. In the alternative, if the existing member selects the option of storing with an existing gifter or recipient, the system proceeds as described in detail below from step 330.

At step 324 if the member is already signed in, the system provides the member the option of selecting recipient, gifter, or wish list at step 330. If the member selects wishlist, then the user proceeds to step 334 to store the item with a wish list and continue shopping at 378. If the member selects gifter, the system proceeds to step 342 where an entry is made into the gifter/recipient table, item stored into the “to-be-assigned table”, and an email is sent to the member gifter. The system then proceeds to step 378 to continue shopping. If the member selects an existing gifter/recipient relationship, then the system proceeds to step 368. However, if the member selects recipient, the system prompts the user to select an occasion, create a new occasion or store item without an occasion at step 338.

If the user selects the option of creating a new occasion at step 338, the system proceeds to step 309, where the user is prompted to enter the occasion information. If at step 312, the user selects an existing occasion from the database component, then the system proceeds to step 390 to allow the user to schedule the occasion as a recurring event. However, if the user selects to create a new occasion, the system proceeds to step 314 to obtain the new occasion information and store this information into the database component. Again, the system proceeds to step 390 to allow the user to schedule the occasion as a recurring event.

If the member wants to store the item without a specific occasion, then the system proceeds to step 340 to store the information into the items to be assigned table. Then, the system proceeds to allow the user to continue shopping at step 378.

If the member has selected an occasion at step 338, the system proceeds to step 336 to provide the member the option of creating the occasion as a recurring event. At step 336, the user is provided the option of making the occasion a recurring event or the system proceeds as a single event at step 392. If the user selects a single event, then the delivery date of the gift item to the recipient is stored along with the captured product information for the gift item at step 392. Additionally, the system provides the user the option of delivering a gift item to the recipient on a recurring basis at step 396.

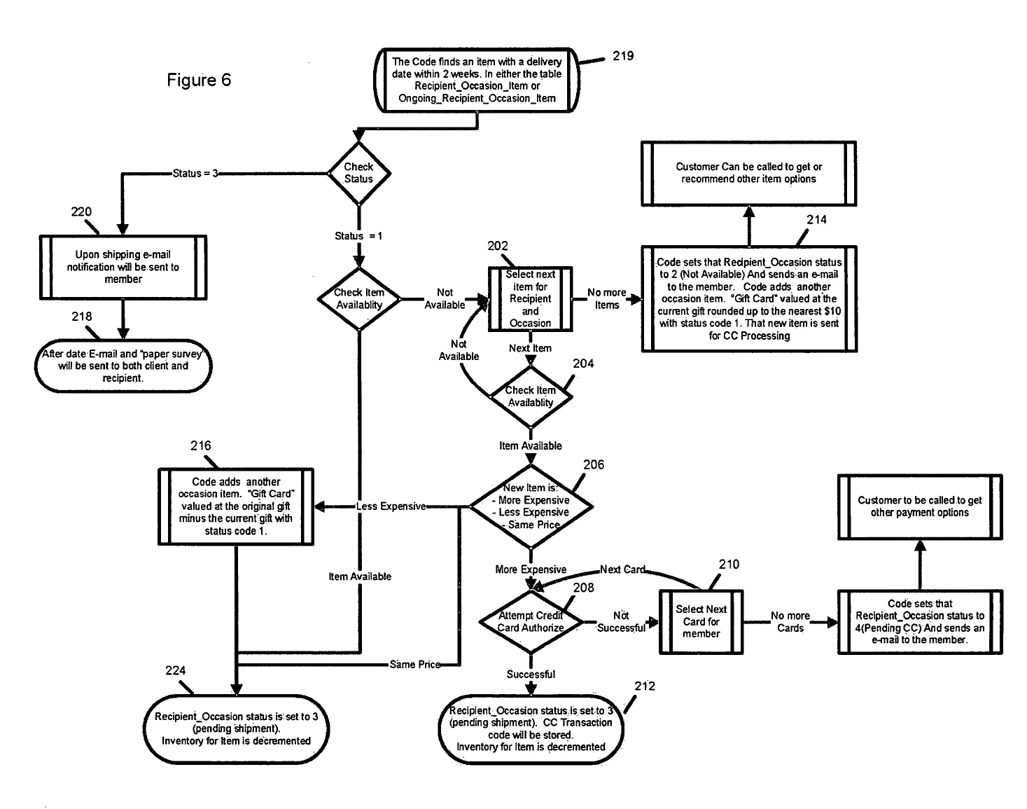

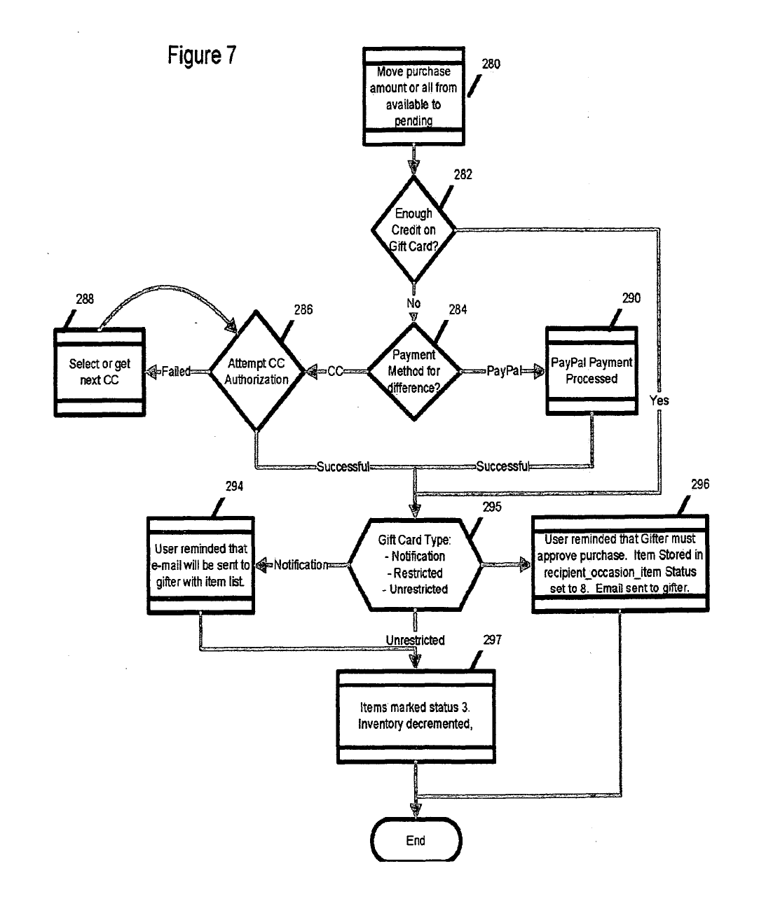

Then the system proceeds to step 394 to secure payment options at this time. If the user has a gift card option, the system proceeds to the gift process outlined in FIG. 7. Otherwise the system proceeds to step 400 to obtain payment information. If user has a credit card option, then an attempt to obtain credit card authorization is attempted at step 402. However, if the user has the paypal option the system proceeds to step 344 to obtain paypal payment. Once payment is successful the system proceeds to step 374 to determine whether the delivery date is immediate or not. At step 376, the system status indicator is set to early stage and the system proceeds as outlined in FIG. 6.

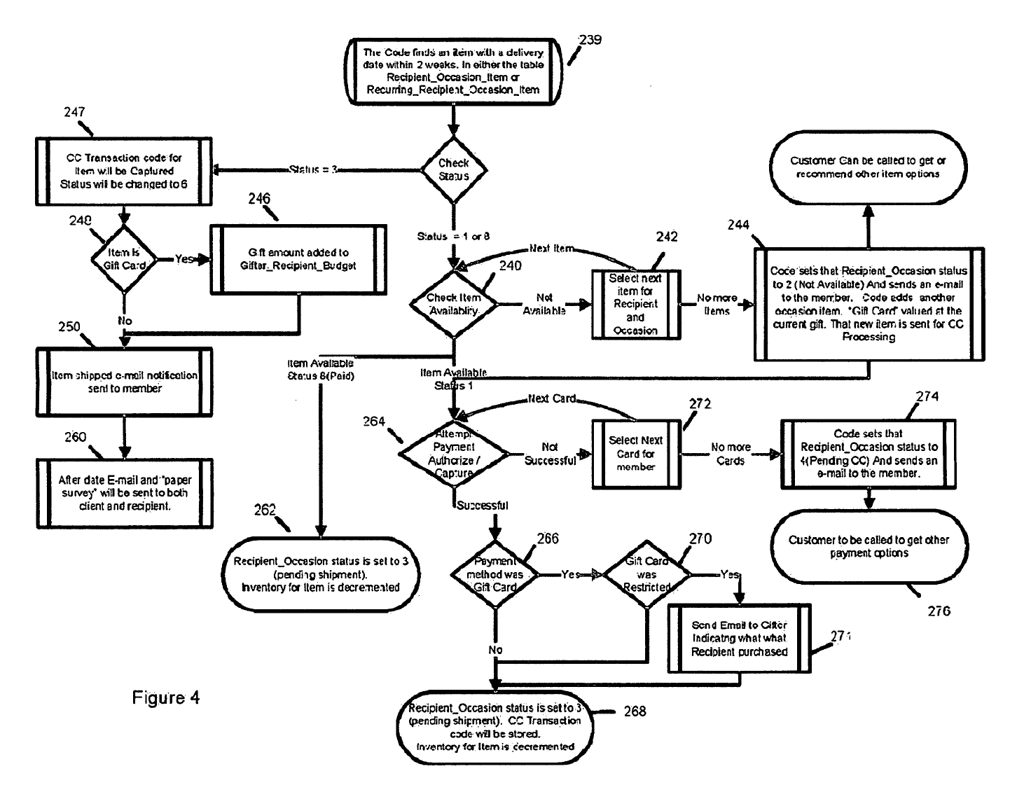

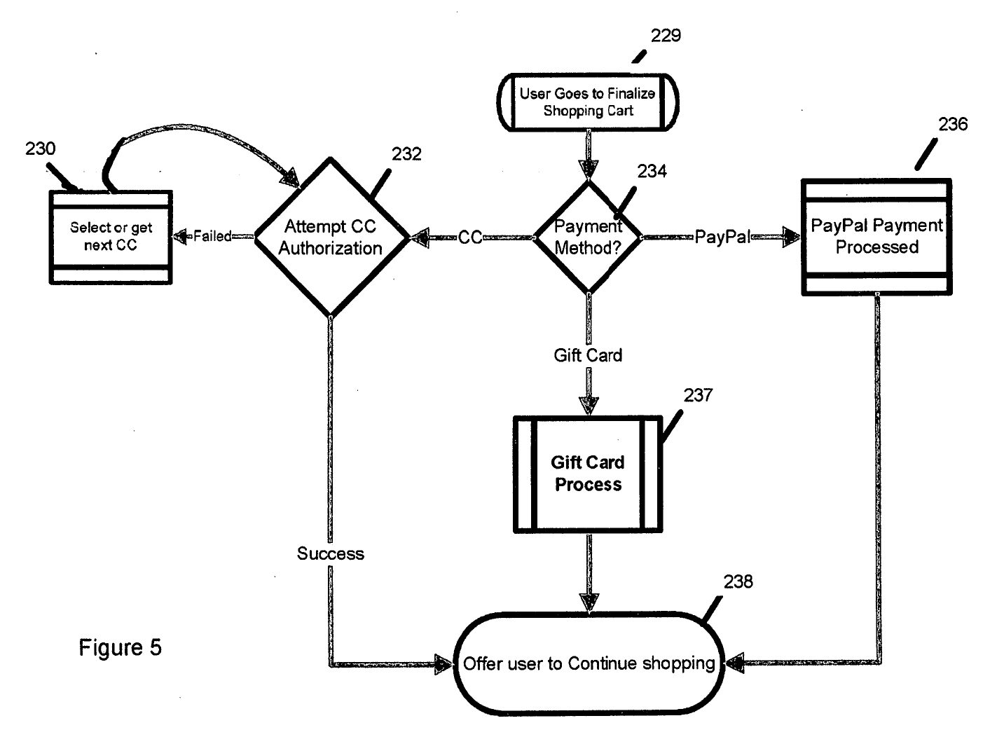

Referring to FIG. 3A, there is shown the steps involved in the late stage payment process. The system proceeds as discussed above, however, the significant difference is that at step 380 wherein the credit card transaction is voided if the delivery date of the gift item is due to be delivered to recipient two weeks from the current date. At step 376, the credit card authorization code is stored in the database component, and the status is set to indicate that this gift item is late stage. Once this information is stored within the database component, the system proceeds as outlined in FIG. 4

Referring to FIG. 6, there is shown a block diagram of the early stage credit shipping protocol. At step 219, the system cycles through the queue of gift items and determines that a particular gift item is due to be delivered within a specified predetermined period of time. By way of illustration, two weeks is shown in the preferred embodiment. When the selected gift item is shipped, a notification is sent to the member at step 220. If the gift item is available within the inventory, the system proceeds to step 224. If the gift item is not available, then the system proceeds to next item on the list until a gift item is found that is available within the inventory. If the newly found gift item retails for the same price as the original selected gift item, the system proceeds to step 224. If the newly found gift item retail price is less expensive then the original selected gift item, the system proceeds to create a gift card at step 216. If the newly found gift item retail price is more expensive then the original selected gift item the system proceeds to collect the difference at step 208. If the gift item list is exhausted, then the system proceeds to create a new gift card and contact the member at step 214.

Referring to FIG. 4, there is shown a block diagram of the late stage shipping protocol. At step 239, the system cycles through the queue of gift items and determines that a particular gift item is due to be delivered within a specified predetermined period of time. By way of illustration, two weeks is shown in the preferred embodiment. When the selected gift item is shipped, a notification is sent to the member at step 250. If the gift item is available within the inventory, the system proceeds to step 264. If the gift item is not available, then the system proceeds to next item on the list until a gift item is found that is available within the inventory. If an item is found that is available, the system proceeds to secure payment at step 264. If the gift item list is exhausted, then the system proceeds to create a new gift card and contact the member at step 244.

Referring to FIG. 7, there is shown a block diagram of the gift card process. In this aspect of the present invention, at step 280, the purchase amount is set to pending for payment. At step 282, the system determines if there is enough credit on the gift card to cover the purchase amount. If there is enough on the gift card, the system proceeds to step 295 otherwise to step 284. At step 295, the system determines whether the gift card is restricted or unrestricted. If the gift card is unrestricted, an email is sent to the gifter with the item list. However, if the gift card is restricted, then the user is reminded that the gifter must approve the purchase at step 296.

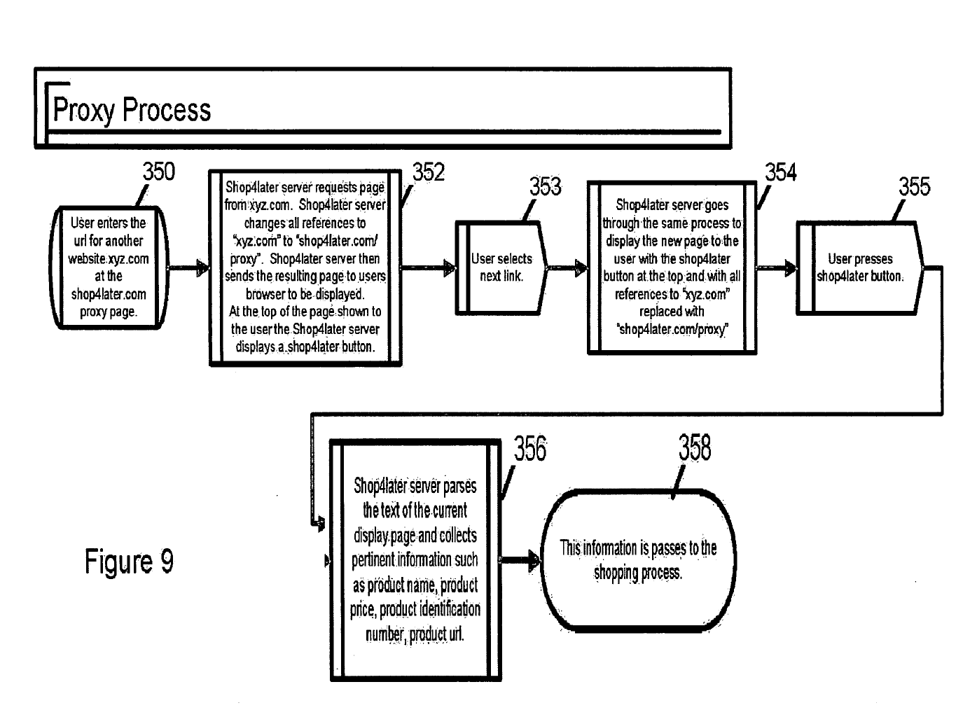

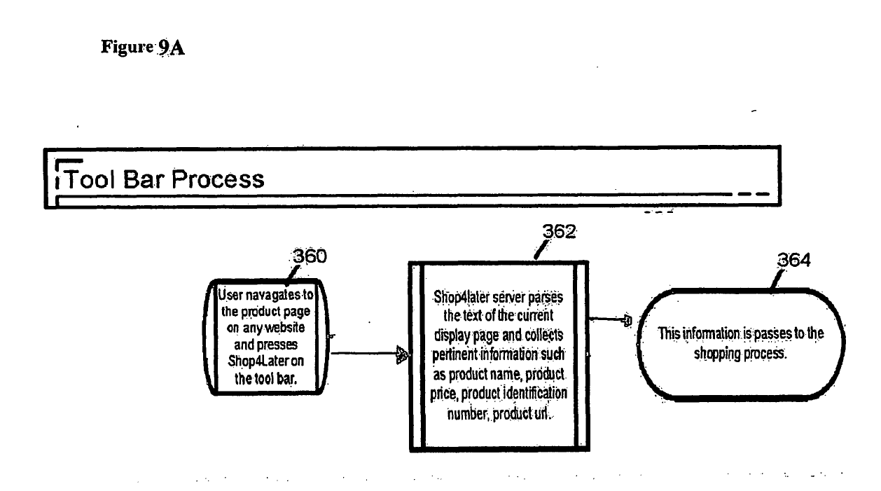

Online stores can become affiliated with the shop4later server application. The system provides the following two ways to capture shopping web page information from the online shopping server: (1) proxy process or (2) tool bar process as shown in FIG. 9. A traditional ecommerce shopping mall is not implemented as part of the present invention. A transparent and seamless interface is used to capture the information from the online store and then to transfer the page structure information to the shop4later process. Proxy process can be implemented as a server or an application, but it acts as an intermediary for requests from clients seeking resources from other on-line shopping website servers. The proxy server evaluates the requests according to its filtering rules and captures the sales information from the actual online server process. With the proxy process, at step 350, the user enters the URL for another on-line store at the proxy page structure. A proxy process can be implemented as a server or an application. At step 352, the client system displays the selected on-line store web page structure. Capturing of the page structure information for the on-line sale can be performed within the proxy process which provides a secure interface between the external on-line shopping website and the client system. For the other feature, when a user presses the shop4later button within the toolbar, page information for the on-line sale is captured and sent through an event hyperlink from within the on-line shopping website to the shop4later website. With this feature, the on-line sale information is captured from within the affiliated on-line shopping website as an event and then transferred to the shop4later server. If the user decides that the selected on-line store does not contain the product of interest, the user is provided the option of selecting another link to another on-line store. At step 354, the process of selecting a new on-line store is repeated until at step 355, the user presses the shop4later control button on the virtual shop4later tool bar to link to the shop4later pre-shopping component of the server system. At step 356, after the shop4later button is pressed, under the control of the pre-shopping component of the server parses the page structure for the pertinent product information and transfers that information into the pre-shopping component process at step 358 and proceeds as outlined in FIGS. 3 and 3A.

In the alternative, a shop4later tool bar is displayed upon affiliated online store web sites at step 360. After the user navigates through the web site and completes the selection of a product gift item, the user presses the shop4later button. At step 362, after the shop4later button is pressed, the server parses the page structure for the pertinent product information and transfers that information into the pre-shopping shopping component process at step 364 and proceeds as outlined in FIGS. 3 and 3A.

1. A method of pre-ordering a gift item from an online store utilizing a client computer system in communication with a server computer system over a computer network, the method comprising:
through a transparent user interface, requesting access to a remote online shopping website;
through the transparent user interface, displaying a virtual page structure on the client computer system containing product information obtained from the remote online shopping website;
upon selection of a gift item from the online store, through the transparent user interface capturing the product information and online store address information from the virtual page structure;
under control of the client computer system, sending a request for pre-ordering the selected gift item containing the product information and at least one online store address information;
under control of a pre-shopping component of the server computer system, receiving the request;
from the pre-shopping component, generating a request for a recipient of the gift item and an occasion delivery date for the gift item for some period of time in the future;
from the pre-shopping component, selecting payment for the gift item at an early stage during ordering of the gift item or at a late payment stage process prior to initiating shipment of the gift item to the recipient;
storing within a database component of the server computer system, the gift item product information and online store address information, the recipient of the gift item, the occasion for delivering the gift item, and the payment information;
tracking by a shipping component of the server computer system the occasion delivery dates of each gift item stored in the database component; and
under control of the shipping component, determining when to initiate an event to deliver the gift item to the recipient based upon the occasion date stored in the database component.

2. The method of claim 1 further comprising:
under the control of the pre-shopping component, registering a consumer as a new member;
under the control of the pre-shopping component, creating a new wish list;
associating the new wish list with an occasion;
storing the selected gift item on the new wish list;
if the new member is a gifter, then prompting the new member to enter name and contact information for storage into the database component; and
providing the new member an option to continue shopping on the online store. under control of the pre-shopping component, storing the gift item in an existing wish list of an existing member.

3. The method of claim 2 further comprising:
under the control of the pre-shopping component, creating a new wish list;
associating the new wish list with an occasion; and
storing the selected gift item on the new wish list.

4. The method of claim 2 further comprising,
if the new member is a gifter, then prompting the new member to enter name and contact information for storage into the database component;
and
providing the new member an option to continue shopping on the online store.

5. The method of claim 1 further comprising:
under control of the pre-shopping component, storing the gift item in an existing wish list of an existing member.

6. The method of claim 1 further comprising under the control of the shipping component, securing payment of the gift item at the time of shipment of the gift item to the recipient for the late payment stage process.

7. The method of claim 1 further comprising:
under control of pre-shopping component for the later stage payment process, requesting a credit card authorization code for payment the gift item at the time of ordering the gift item;
voiding the credit card authorization;
storing the authorization code in the database component; and
decrementing inventory to represent a sale of the gift item.

8. The method of claim 1 further comprising under the control of the pre-shopping component, securing payment of the gift item when the order of the gift item is placed by the gifter for the early stage payment process.

9. The method of claim 2 further comprising:
if the new member is a recipient, then prompting the new member to enter name and contact information for storage into the database component;
providing an option to the new member of selecting an existing occasion delivery date from the database component for the gift item or in the alternative for the gift item creating a new occasion delivery date for storage into the database component; and
providing a second option to the new member of making the existing or the new occasion date a recurring event within the database component, wherein the recipient is automatically shipped the gift item upon recurrence of the occasion delivery date.

10. The method of claim 1 further comprising:
under the control of the pre-shopping component, logging in a consumer as an existing member,
providing an option to the existing member of selecting an existing occasion delivery date for the gift item from the database component or in the alternative creating a new occasion delivery date for storage into the database component; and
providing a second option to the existing member of setting the existing or the new occasion as a recurring event within the database component, wherein the recipient is automatically shipped the gift item upon recurrence of the occasion delivery date.

11. The method of claim 1 further comprising:
upon maturation of the occasion delivery date of the gift item within the later stage payment process and under control of the shipping component, checking availability of the gift item;
if the gift item is not available, selecting a new gift item from an alternative gift item list for the recipient;
if a new gift item cannot be selected, then creating a gift card for the value of the gift item;
if the new gift item is selected that is more expensive than the gift item, securing payment for the difference between the new gift item and the unavailable gift item.

12. The method of claim 1 further comprising:
upon maturation of the occasion delivery date of the gift item within the early stage payment process and under control of the shipping component, checking availability of the gift item;
if the gift item is not available, selecting a new gift item from an alternative gift item list for the recipient;
if a new gift item cannot be selected, then creating a gift card for the value of the gift item;
if a new gift item is selected that is more expensive than the gift item, securing payment for the difference between the new gift item and the unavailable gift item.

13. The method of claim 1 wherein the transparent interface is a proxy process which captures online shopping information.

14. The method of claim 1 wherein the transparent interface is an event within the on-line shopping website which causes the transfer of the online shopping information upon activation of the event.

15. The method of claim 1 further comprising if payment is by a restricted gift card, requesting approval from the gifter prior to proceeding with ordering of the gift item.

16. A system for pre-ordering a gift item from an online store, the system comprising:
a client computer system in communication with a server computer system over a computer network;
through a transparent user interface, a means for requesting access to an online shopping website;
through the transparent user interface, a means for displaying a virtual page structure on the client computer system containing product information;
upon selection of a gift item from the online store, a means for capturing the product information and online store address information from the virtual page structure;
under control of the client computer system, a means for sending a request for pre-ordering the selected gift item containing the product information and the at least one online store address information;
under control of a pre-shopping component of the server computer system, a means for receiving the request;
from the pre-shopping component, a means for generating a request for a recipient of the gift item and an occasion delivery date for the gift item for some period of time in the future;
from the pre-shopping component, a means for selecting payment for the gift item at an early stage during ordering of the gift item or a late payment stage process prior to initiating shipment of the gift item to the recipient;
a means for storing within a database component of the server computer system, the gift item product information and online store address information, the recipient of the gift item, the occasion for delivering the gift item, and the payment information;
a means for tracking by a shipping component of the server computer system the occasion delivery dates of each gift item stored in the database component;

17. The system of claim 17 further comprising under the control of the pre-shopping component, a means for registering a consumer as a new member.

18. The system of claim 16 further comprising:
under the control of the pre-shopping component, a means for creating a new wish list;
a means for associating the new wish list with an occasion; and
a means for storing the selected gift item on the new wish list;
if the new member is a sifter, a means for prompting the new member to enter name and contact information for storage into the database component;
a means for a new member to select an existing occasion delivery date from the database component for the gift item or in the alternative for the gift item creating a new occasion delivery date for storage into the database component;
a means for allowing the new member an option of making the existing or the new occasion date a recurring event within the database component, wherein the recipient is automatically shipped the gift item upon recurrence of the occasion delivery date,
and
providing the new member an option to continue shopping on the online store. under control of the pre-shopping component, a means for storing the gift item in an existing wish list of an existing member.

19. The system of claim 18 further comprising,
if the new member is a gifter, a means for prompting the new member to enter name and contact information for storage into the database component; and
providing the new member an option to continue shopping on the online store.

20. The system of claim 17 further comprising:
under control of the pre-shopping component, a means for storing the gift item in an existing wish list of an existing member.

21. The system of claim 16 further comprising under the control of the
shipping component, a means for securing payment of the gift item at, the time of shipment of the gift item to the recipient for the late payment stage process.

22. The system of claim 16 further comprising:
under control of pre-shopping component for the later stage payment process, a means for requesting a credit card authorization code for payment of the gift item at the time of ordering the gift item;
a means for voiding the credit card authorization;
a means for storing the authorization code in the database component; and
a means for decrementing inventory to represent a sale of the gift item.

23. The system of claim 16 further comprising under the control of the pre-shopping component, a means for securing payment of the gift item when the order of the gift item is placed by the gifter for the early stage payment process.

24. The system of claim 18 further comprising:
if the new member is a recipient, a means for prompting the new member to enter name and contact information for storage into the database component; and
a means for a new member to select an existing occasion delivery date from the database component for the gift item or in the alternative for the gift item creating a new occasion delivery date for storage into the database component; and
a means for allowing the new member an option of making the existing or the new occasion date a recurring event within the database component,
wherein the recipient is automatically shipped the gift item upon recurrence of the occasion delivery date.

25. The system of claim 16 further comprising:
under the control of the pre-shopping component, a means for logging in a consumer as an existing member,
a means for allowing the existing member the option of selecting an existing occasion delivery date for the gift item from the database component or in the alternative creating a new occasion delivery date for storage into the database component; and
a means for allowing the existing member a second option of setting the existing or the new occasion as a recurring event within the database component, wherein the recipient is automatically shipped the gift item upon recurrence of the occasion delivery date.

26. The system of claim 16 further comprising:
upon maturation of the occasion delivery date of the gift item within the later stage payment process and under control of the shipping component, a means for checking availability of the gift item;
if the gift item is not available, a means for selecting a new gift item from an alternative gift item list for the recipient;
if a new gift item cannot be selected, then creating a gift card for the value of the gift item;
if the new gift item is selected that is more expensive than the gift item, a means for securing payment for the difference between the new gift item and the unavailable gift item.

27. The system of claim 16 further comprising:
upon maturation of the occasion delivery date of the gift item within the early stage payment process and under control of the shipping component, a means for checking availability of the gift item;
if the gift item is not available, a means for selecting a new gift item from an alternative gift item list for the recipient;
if a new gift item cannot be selected, then a means for creating a gift card for the value of the gift item;
if a new gift item is selected that is more expensive than the gift item, a means for securing payment for the difference between the new gift item and the unavailable gift item;

28. The system of claim 17 further comprising a means for linking a plurality of online stores with the pre-shopping component.

29. The system of claim 16 further comprising if payment is by an unrestricted
gift card, a means for notifying the gifter of the purchase.

30. The system of claim 16 further comprising if payment is by a restricted gift
card, a means for requesting approval from the gifter prior to proceeding with ordering of the gift item.
